(19) United States
(12) Patent Application Publication
(10) Pub. No.: US 2006/0127158 A1
(43) Pub. Date: Jun. 15, 2006

(54) Implantable electrical lead retention system and method

(75) Inventors: Robert L. Olson, Vadnais Heights, MN (US); Charmaine K. Harris, Woodbury, MN (US); Joe P. Ricci, Ham Lake, MN (US)

Correspondence Address: MEDTRONIC, INC., 710 MEDTRONIC PARK, MINNEAPOLIS, MN, 55432-9924, US

(73) Assignee: Medtronic, Inc., Minneapolis, MN (US)

(21) Appl. No.: 11/255,324

(22) Filed: Oct. 21, 2005

Related U.S. Application Data
(60) Provisional application No. 60/621,008, filed on Oct. 21, 2004.

(51) Int. Cl. B43K 21/02

(52) U.S. Cl. 401/53

(57) ABSTRACT

A medical lead anchor is described for anchoring a lead relative to the tissue. An exemplary double-acting collet mechanism may be provided in the anchor. The exemplary double-acting collet mechanism includes a first collet assembly, which provides greater retentive force against the lead in one direction, and a second collet assembly, which provides greater retentive force against the lead in other direction. Relatively soft and flexible elastomeric tissue-anchoring members may be provided along opposite ends of the medical lead anchor. These and other exemplary embodiments are described, including for example the combination of the anchor with a lead, a system and a method of use.

### RELATED APPLICATION

This application claims priority to provisional U.S. Application Ser. No. 60/621,008, filed Oct. 21, 2004. The entire contents of U.S. Application Ser. No. 60/621,008, filed Oct. 21, 2004, are incorporated herein by reference.

### FIELD

This application relates generally to implantable medical leads and anchors, and particularly to a lead retention system for anchoring an implantable electrical lead or catheter to biological tissue.

### BACKGROUND

Controlled placement of drug delivering catheters in the intrathecal space or controlled placement of leads in the epidural space, intrathecal space, or in peripheral nerve applications is highly desirable. Precision in placement may lead to improved treatment, as drugs and stimulation are released at the point or points at which treatment causes maximum beneficial effects. Physicians desire controlled placement for these reasons. When implanting an epidural lead, a physician may surgically open the human body to the epidural space, and then insert the lead into the epidural space to the desired location. Fluoroscopy aids the physician, and trial and error tests of treatment define the desired location(s) for treatment.

U.S. Pat. No. 5,843,146, which is assigned to Medtronic, discloses a medical lead anchor for anchoring a medical lead relative to, for example, the epidural space of the spinal cord. The anchor disclosed in the '146 patent includes a locking device defining a collet, a collet driver and a handle. U.S. Pat. No. 5,843,146 is hereby incorporated herein by reference.

### BRIEF SUMMARY OF EXEMPLARY EMBODIMENTS

Exemplary embodiments of a lead retention system or anchoring system are adapted to prevent lead migration after implant. Exemplary soft ends may also help provide kink resistance near the fascia entry location. As used herein, the term, “exemplary” is used in the sense of for example or for purposes of illustration, and not in a limiting sense.

Exemplary embodiments may provide mechanical gripping of leads with collet based actuation, such as for example, a double collet mechanism in which two collet mechanisms may be provided in one anchor; an anchor having soft flexible ends to protect leads during entry into the fascia region; snap-fit or quick-connection features to speed assembly and implantation; or the ability to accommodate multiple (different) lead diameters with a single model of anchor. Such exemplary embodiments may provide a medical lead anchor that anchors an epidural lead or intrathecal catheter and allows the lead or catheter to be readily, securely positioned and repositioned as desired. The preferred exemplary anchor may provide substantially the same retentive force in both directions along the lead or catheter.

In a first exemplary embodiment, a medical lead anchor is provided for anchoring a lead relative to the epidural space of a human spinal cord. The anchor generally comprises a body having first end defining a first collet socket and second end defining a second collet socket. Each of the first and second collet sockets may be deflectable between a locked position in which the collet socket is adapted to be fastened to a lead, and an unlocked position in which the collet socket is adapted to allow movement of the lead relative to the collet socket. A first collet collar and a second collet collar engage the first and second collet sockets, respectively, and are mounted on the body for rotation relative to the first and second collet sockets, respectively, to move the first and second collet sockets between their locked and unlocked positions. The anchor body is thereby adapted to be fitted to the lead, and the first and second collet sockets adapted to be fastened to the lead to the anchor the lead against movement relative to the anchor. The anchor is adapted to be fastened to human tissue adjacent the epidural space, thereby facilitating anchoring the lead relative to the human tissue and epidural space.

In a preferred example of the first embodiment, the first end of the body defines a first direction and the second end of the body defines a second direction opposite the first direction. The body may further include a central portion between the first and second collet sockets. Each of the first and second collet sockets may include at least two deflectable cantilever arms for releasably engaging a lead, with the deflectable cantilever arms of the first collet socket extending from the central portion of the body in the first direction, and the deflectable cantilever arms of the second collet socket extending from the central portion of the body in the second direction. The first collet socket when in its locked position may provide greater retentive force against the lead in one of the first and second directions than in the other of the first and second directions, and the second collet socket when in its locked position may provide greater retentive force against the lead in the aforesaid other of the first and second directions than in the aforesaid one of the first and second directions.

In a second exemplary embodiment, a medical lead anchor is provided for anchoring a lead relative to tissue. The anchor generally comprises a body having first and second ends and a lumen extending between the first and second ends for receiving a lead, and a double-collet, lead fastening mechanism. The double-acting, lead-fastening mechansim includes first and second cantilever structures and first and second collet collars. The first cantilever structure extends from the first end of the body in a first direction, and the second cantilever structure extends from the second end of the body in a second direction opposite the first direction. Each of the first and second cantilever structures are adapted to deflect between a locked position in which the cantilever structure is adapted to fasten against the lead, and an unlocked position in which the cantilever structure is not fastened against the lead. The first collet collar and the second collet collar may each be mounted on the body for rotational movement relative to the body between a first position and a second position. In the first position of the first collet collar, the first collet collar does not to hold the first cantilever structure in its locked position so that the first cantilever structure is free to move to its unlocked position. In the first position of the second collet collar, the second collet collar does not hold the second cantilever structure in its locked position so that the second cantilever structure is free to move to its unlocked position. In the second position of the first collet collar, the first collet collar holds the first cantilever structure in its locked position. In the second position of the second collet collar, the second collet collar holds the second cantilever structure in its locked position.

In a third exemplary embodiment, an implantable medical anchor is provided for anchoring an implantable medical lead or catheter to tissue. The anchor of the third exemplary embodiment has a first end and a second end, and a lumen extending between the first and second ends. The lumen defines a longitudinal axis wherein the direction along the longitudinal axis from the first end toward the second end of the anchor constitutes a first direction and the direction along the longitudinal axis from the second end toward the first end constitutes a second direction. The lumen is adapted to slidably receive a lead or catheter. A first locking means is provided for releasably locking the anchor to a lead such that the first locking means provides greater retentive force against the lead sliding relative to the anchor in the first direction than in the second direction, and a second locking means is provided for releasably locking the anchor to a lead such that the second locking means provides greater retentive force against the lead sliding relative to the anchor in the second direction than in the first direction.

While it may be appreciated that any suitable selectively releasable locking means that provides a directional retention force may be employed as a first or second locking means of the third exemplary embodiment, a preferred exemplary embodiment of each of the first and second locking means may include a collet including a collet socket formed by at least two deflectable cantilever arms. The deflectable cantilever arms of the first locking means may be oriented to extend longitudinally outwardly substantially in the first direction and the deflectable cantilever arms of the second locking means may be oriented to extend longitudinally outwardly substantially in the second direction.

In a fourth exemplary embodiment, a method is provided for anchoring an implantable medical lead to tissue to retain the lead in the epidural space for spinal cord stimulation. The exemplary method generally comprises (a) positioning at least a portion of the implantable medical lead within the epidural space; (b) inserting the lead in the lumen of the anchor and sliding the anchor into position on the implantable medical lead; and (c) locking each of the first and second collet assemblies against the lead; and (d) fixing the anchor relative to tissue. Steps (b) and (c) may occur before, during or after step (a). For example, the lead may be inserted in the lumen of the anchor before the lead is positioned in the epidural space, and the anchor may be slid into position on the medical lead and locked to the lead during or after positioning the lead in the epidural space.

In a fourth exemplary embodiment, an implantable medical anchor is provided in which a collet type locking mechanism is employed together with elastomeric end caps. In preferred exemplary embodiments of the fourth exemplary embodiment, single or double collet mechanisms may be employed.

### BRIEF DESCRIPTION OF THE DRAWINGS

FIG. 1 shows a general environmental view for an embodiment of a neurostimulation system used to stimulate the spinal cord.

FIG. 2 shows the neurostimulation system of FIG. 1.

FIG. 3 shows an embodiment of a neurostimulation lead used in the neurostimulation system of FIGS. 1 and 2.

FIG. 4 is a perspective view of an embodiment of a lead retention system that includes a double-collet anchor having a body with threads having a keyed feature, end caps, and soft flexible ends.

FIG. 5 is a perspective exploded view of a first exemplary embodiment of a lead retention system having an anchor in which the body is provided with retention teeth, and two end caps that can be turned on the threads or snapped over the threads.

FIG. 6 is a side view of the anchor of FIG. 5.

FIG. 7 is a side view of an exemplary body of the anchor of FIGS. 5 and 6.

FIG. 8 is a perspective view of the anchor of FIGS. 5-7 in which an end cap is separated and shown with arrows indicating the ability to snap the end cap on the threads or turn the end cap on the ends to connect the end cap to the body of the anchor.

FIG. 9A is an enlarged view of an exemplary end cap of the type shown in FIGS. 4-9, illustrating a ramped tooth and strain relief slots.

FIG. 9B is a cross sectional view through a second exemplary embodiment of the end cap.

FIG. 10 is a perspective view of the lead retention system of FIGS. 5-9 in which the end caps are connected to the body of the anchor.

FIG. 11 is an environmental view of the lead retention system of FIGS. 5-10 in which sutures attach the system to fascia or other biological tissue.

FIG. 12 is a perspective exploded view similar to FIG. 5 illustrating a second exemplary embodiment of the lead retention system in which the body of the anchor is provided with ramped retention teeth, and two end caps that can be snapped over the retention teeth.

FIG. 13 is a side view of the anchor of FIG. 12.

FIG. 14 is a side view of an exemplary body of the anchor of FIGS. 12 and 13.

FIG. 15 is a perspective view of the anchor of FIGS. 12-14 in which an end cap is separated and shown with arrows indicating the ability to snap the end cap on the threads or crank the end cap back and forth to separate it from the body of the anchor.

FIG. 16 is a perspective view of the lead retention system of FIGS. 12-15 in which the end caps are connected to the body of the anchor.

FIG. 17 is an environmental view of the lead retention system of FIGS. 12-16 in which sutures attach the system to fascia or other biological tissue.

### DETAILED DESCRIPTION OF EXEMPLARY EMBODIMENTS

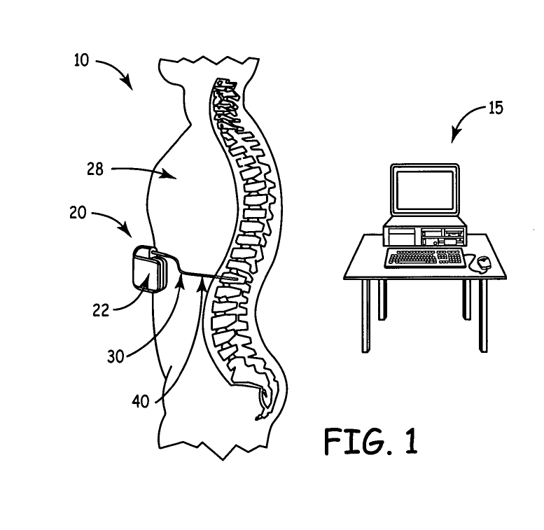

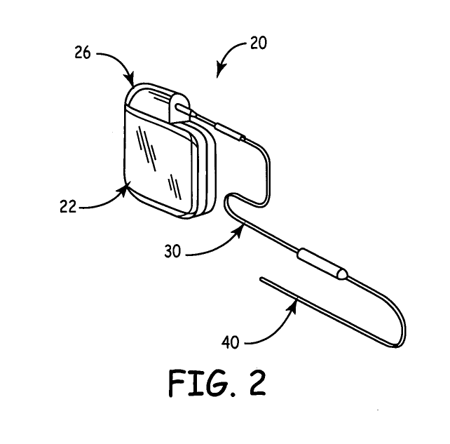

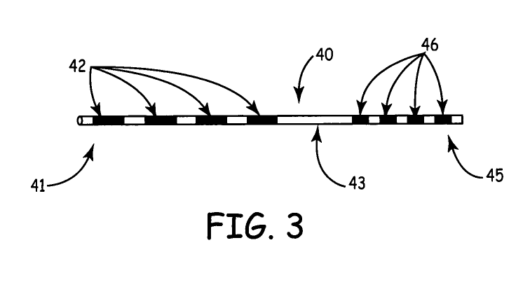

FIG. 1 shows a general environmental view 10 for an exemplary implantable neurostimulation system embodiment. Neurostimulation systems may be used to treat conditions such as pain, movement disorders, pelvic floor disorders, gastroparesis, and a wide variety of other medical conditions. As illustrated in FIGS. 1 and 2, the neurostimulation system 20 may include a neurostimulator 22, one or more stimulation lead extension(s) 30, and one or more stimulation lead(s) 40. The neurostimulator 22 is typically implanted subcutaneously in the patient's body 28 at a location selected by the clinician. The stimulation lead 40 is typically fixed in place near the location selected by the clinician using a device such as an adjustable anchor.

The exemplary implantable neurostimulator 22 has a housing, a power supply in the housing 24, and stimulation electronics in the housing in electrical communication with the battery and in electrical communication with a connector block 26, which is also known as a terminal block.

The exemplary stimulation lead 40 has a proximal end portion 45, a distal end portion 41 and a lead body 43 extending between the proximal end portion 45 and distal end portion 41. The proximal end portion 45 has at least one electrical connector 46 (also known as electrical terminals or contacts), with various standard pluralities, such as four or eight electrical contacts, being typical. The distal end portion 41 has at least one stimulation electrode 42, with various standard pluralities, such as four or eight electrodes, being typical.

There is at least one lead conductor 50 contained in the lead body 43 that is electrically connecting the electrical connector 46 to the stimulation electrode 42. Typically, at least one conductor may be used to establish electrical communication between a single electrical connector/electrode pair, although alternative examples include multiplexing or bus features within the lead to allow use of fewer conductors along the length of the lead than the number of electrodes. As used herein, “conductive means” or “means for electrical communication between electrodes and electrical connectors include the foregoing examples or any alternative structure to allow selection or electrical activation of one or more electrode.

A lead retention system using mechanical gripping may be used to prevent migration of the lead after a therapy site has been chosen. The exemplary anchor of this lead retention system include a collet-type actuation system where the gripping forces are increased with the number of turns of the end cap of the collet. Preferred exemplary embodiments of this anchor use a collet on both ends (i.e., two collets) to increase the overall system retention. An added benefit of an exemplary collet system is the ability to accommodate multiple lead diameters. The system may also employ soft flexible ends to mitigate potential lead issues related to bending of the lead as it enters the fascia. To aid in decreasing the time required to activate the anchor, snap-fit or quick-connection features may be employed in the anchor system. Such snap-fit or quick-connection features may be used to allow the user to slide the anchor pieces into the near-final settings before snap connection of the pieces or twisting or locking threaded end pieces into position.

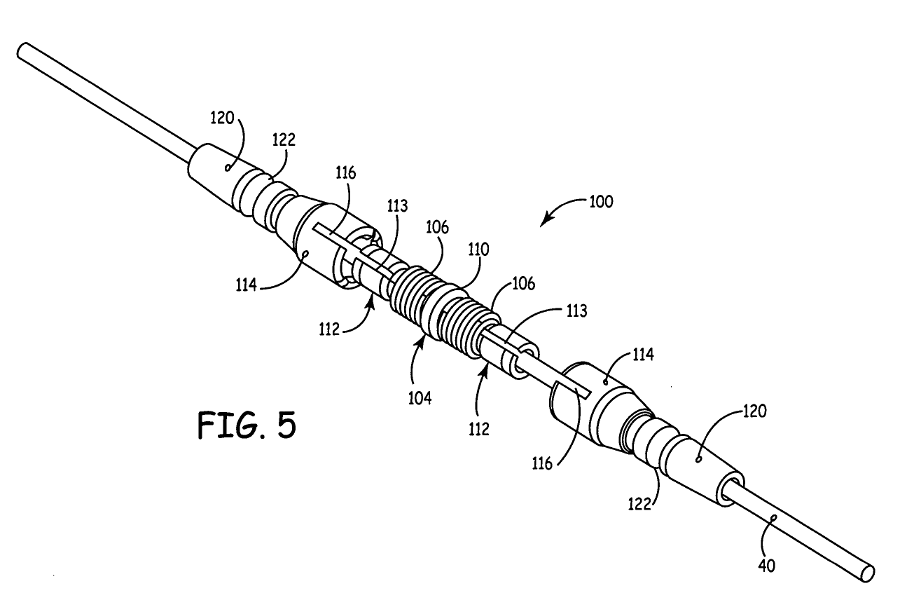

As illustrated in FIG. 5, an exemplary lead retention system 100 includes a double-collet anchor 102 having a body 104. A threaded portion 106 may be provided on each end of the body 104, and the anchor body 104 may optionally include a rib or feature 110 for grasping the lead body 104 or on which may be provided a suture-receiving groove. The body 104 may be formed of any suitable material, such as for example polycarbonate or polysulfone.

The body 104 has a lumen defining a longitudinal axis, with the lumen being adapted to receive a lead. The opposite directions along the longitudinal axis may be termed the “first direction” and the “second direction,” and the direction perpendicular to the longitudinal axis may be termed the “lateral direction.” or referred to by the term “radially.” As used herein, the term “longitudinal” is not intended to imply that the body must be elongate but is merely used to provide spatial orientation when discussing the anchor. The longitudinal axis or these directions may also be contemplated by reference to a lead on which the anchor is mounted or in connection with the lumen or passageway of the anchor, collet socket, collet collar or other exemplary tubular structures of the anchor. As used herein, the term “tubular” is refers to any structure having a passageway or lumen through the structure, and is not limited to such structures that form a generally cylindrical configuration or otherwise have a round cross section.

Collet means, such as an exemplary collet collar/socket assembly, may be provided. As used herein, the term “collet socket” refers to a structure that engages the part to which the collet is being fasterned (e.g., a lead or catheter), and the term “collet collar” refers to a structure that engages or activates the collet socket, for example, by movement to a position in which the collet collar squeezes or holds the collet socket in a locked position in which the collet socket fastens or locks on, for example, the lead or catheter.

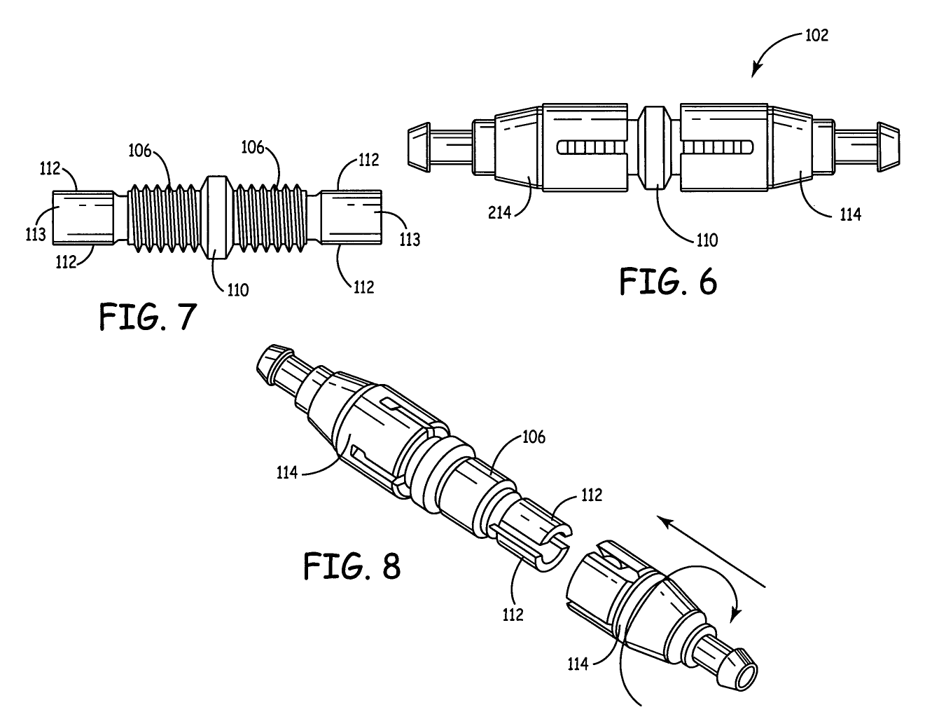

An exemplary collet socket may be provided, as part of this collet collar/socket assembly, by deflectable cantilever members 112, which may extend from opposite ends of the body 104 for releasably retaining the lead within the lumen of the body 104. For example, the deflectable cantilever arms 112 of the first collet socket may extending from the central portion of the body in the first longitudinal direction, and the deflectable cantilever arms of the second collet socket extending from the central portion of the body in the second direction. The cantilever members 112 may be integral (i.e., form a one-piece construction) with the body, or may be part of a separate structure assembled with the body. Two opposite slots 113 are defined between the two cantilever members of each end in the exemplary embodiment illustrated in FIG. 6, although it will be understood that other numbers of cantilever member and slots could be used. The deflectable cantilever members 112 form a preferred exemplary embodiment of a cantilever structure or collet socket.

End caps or collet collars 114 are provided to hold the cantilever members 112 against the lead. This may be accomplished by either using the collet collars 114 to deflect the cantilever members 112 against the lead body, or merely to retain the cantilever members 112 against deflection away from the lead body. In a preferred exemplary embodiment of the end cap 114, the end cap 114 is provided with four slots 116 for compliance, and to facilitate making a snap-fit or quick connection with the body of the anchor.

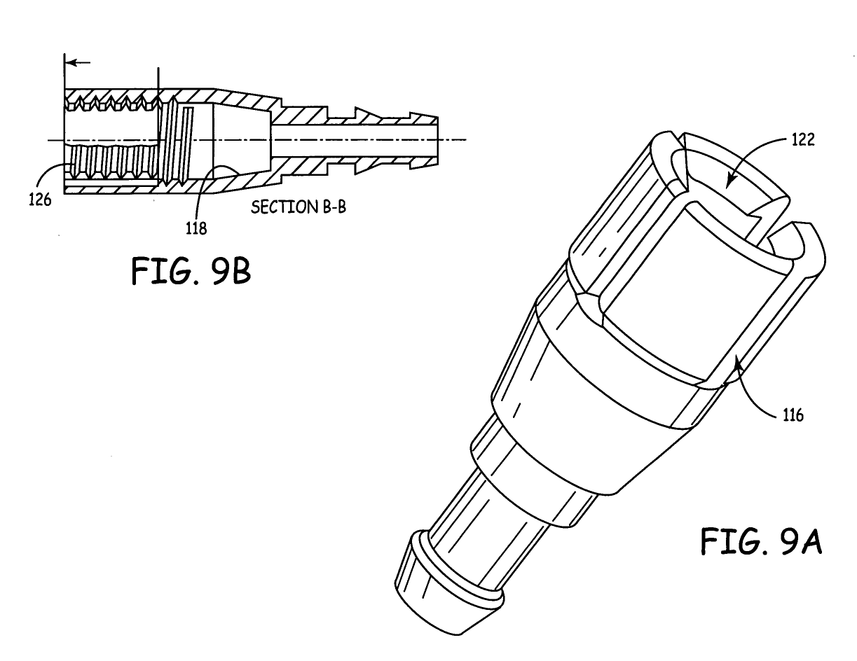

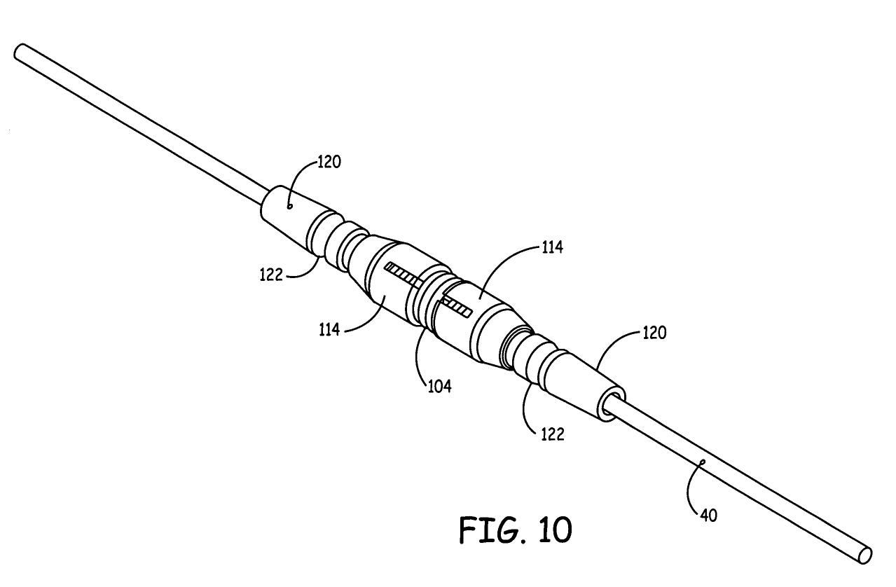

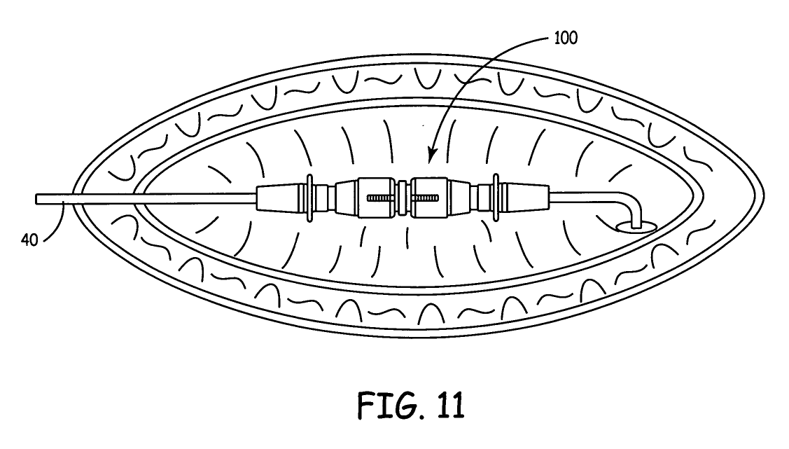

Each of the collar collars 114 defines passageway having inner and outer ends. The inner end is the end extending toward the body of the anchor and the outer end is the end extending away from the anchor. The passageway of the collet collar 114 receives the collet socket 112. Along or adjacent the inner end of the passageway, each collet collar 114 may be provided, for example, with a single ramped tooth 124 (as illustrated in FIG. 9A), or with a threaded structure 126 (as illustrated in FIG. 9B), or any other suitable structure that provides a means for retaining the collet collar on the anchor body 104.

The inside of each collet collar 114 may also be provided with a funnel-shaped portion 118, which may be located for example in a portion of the passageway adjacent the outer end of the passageway. The funnel-shape of the funnel-shaped portion 118 provides the passageway with converging walls defining smaller-and-smaller diameters along the funnel-shaped portion in the direction toward the outer end of the passageway. It may be appreciated that, as the collet collar 114 is moved toward the body (e.g., by rotation along threads in the exemplary embodiment of FIGS. 5-8), the funnel-shaped portion 118 will engage the cantilever arms of the collet socket 112 and hold them against radially outward deflection, thereby holding the anchor in position on the lead 40. This may be accomplished by actually having the funnel-shaped portion deflect the cantilever arms of the collet socket 112 in the radially inward direction, or merely by having the funnel-shaped portion hold the cantilever arms against radially outward movement.

In a preferred example illustrated in FIGS. 5-8, each collet collar 114 is so mounted on the body that rotation of the collet collet moves the collet collar longitudinally relative to the body between (a) a first position in which the funnel shaped portion of the passageway of the collet collar does not hold the collet socket in its locked position, and (b) a second position in which the funnel shaped portion of the passageway of the collet collar engages the collet socket to hold the collet socket in its locked position. This may be accomplished, for example, by the threaded engagement of the single ramped tooth of FIG. 9A or the threaded structure of FIG. 9b with the threaded portions 106 on the body. The exemplary collet collars 114 of FIGS. 5-9 are adapted to allow both a snap-fit, quick connection and to allow rotational connection and disconnection.

As illustrated in FIG. 7, both threaded portions 106 may be provided with the same handed threads (right or left), which may allow the first and second collet collars to be moved from their first position to their second position by a single twist of the first collet collar relative to the second collet collar, resulting in both moving relative to the body. Alternatively, one of the threaded portions 106 may be provided with left-hand threads and the other threaded portion 106 may be provided with right hand threads.

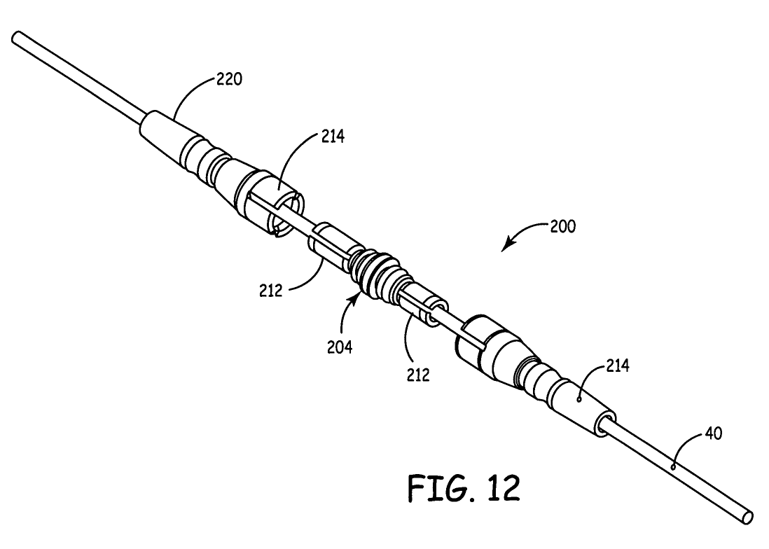

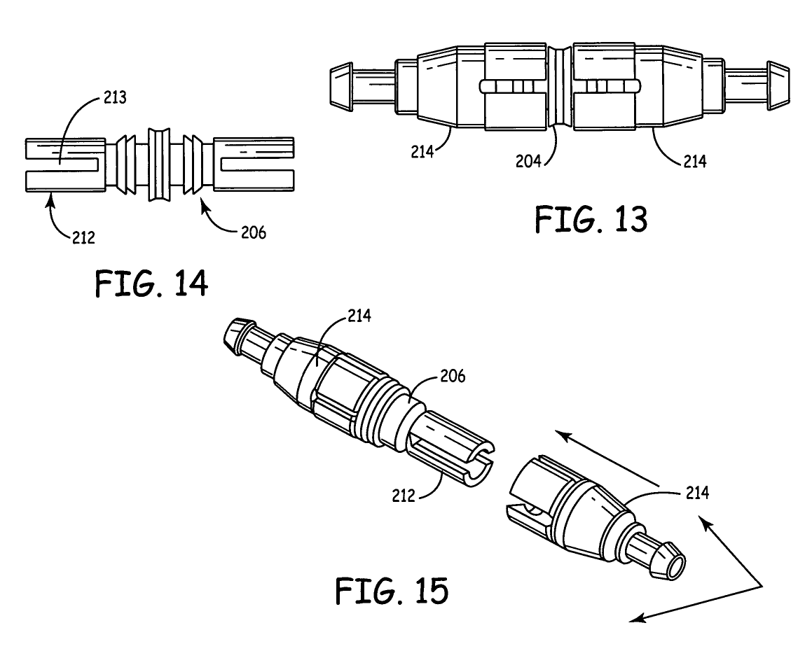

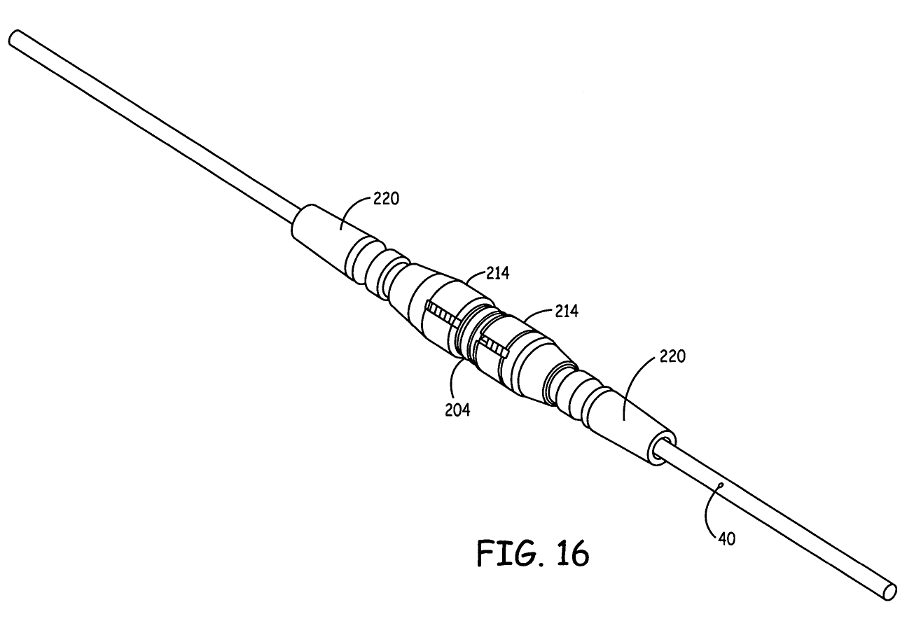

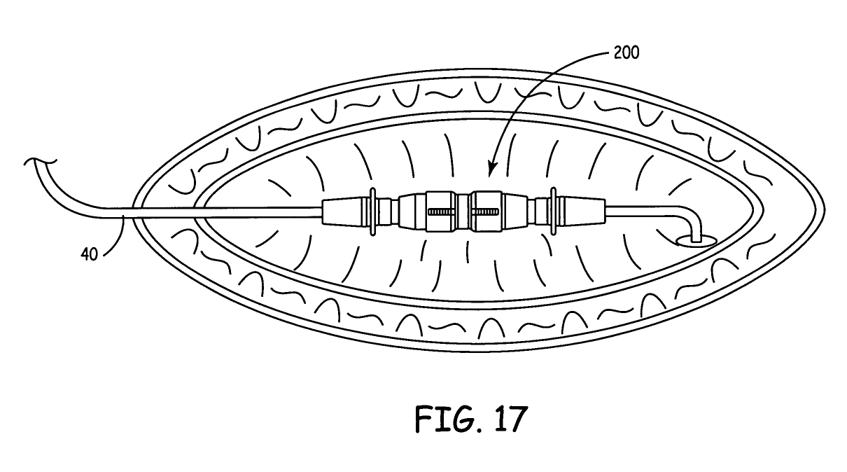

FIGS. 12-16 illustrate an embodiment of the lead retention system 200 in which the collet collars 214 form a snap-fit, quick connection with the teeth 206 of the body 204 but in which the teeth 206 of the body 204 do not form a screw-thread structure and thus rotation of the collet collars 214 will not tighten or loosen the collet collars 214. The illustrated multiple teeth 206 on the body 204 allow adjustment of the tightness of the fit, and disconnection may still be possible although preferably by use of a tool adapted to release the collet collars 214 from the teeth 206. Various reference numbers in the 200 series are used in connection with FIGS. 12-16 but not otherwise mentioned in this text other than by noting that such reference numbers refer to similar features as identified by 100 series reference numbers having the same last two digits.

For purposes of illustration of the general scale of various exemplary implantable medical leads, the exemplary body 104 and collet collars 114 of the lead retention system 100 (e.g., FIG. 7) may have a length of approximately 1.16 inches (29 mm) and an outside diameter at its widest point of approximately 0.206 inches (5 mm). In the exemplary embodiment illustrated in FIG. 14, the exemplary body 204 and collet collars 214 of the lead retention system 200 may have a length of approximately 1.06 inches (27 mm) and an outside diameter at its widest point of approximately 0.20 inches (5 mm). In either case, the exemplary length includes the central portion of the body, the first and second collet sockets, and the collet collars.

It may be appreciated that each of the collet sockets when in its locked position may provide greater retentive force against the lead in one direction than in the other or opposite direction. Without intending to limit the scope of the invention by a discussion of theory, this retentive directionality of collet-type mechanisms is believe to be due to the orientation of the deflectable cantilever arms, and to generally result in greater retention against longitudinal slipping in the direction into the cantilever arms (toward by body). It may also be appreciate that by providing two collet-type locking mechanisms, each having an orientation opposite the other, a substantially similar retentive force may be provided against longitudinal sliding motion of the lead relative to the anchor in either direction. This advantage may be employed, for example, to increase the overall retentive force of the anchor, or to allow use of a lighter and more compact anchor without undue loss of retentive force, or a combination thereof.

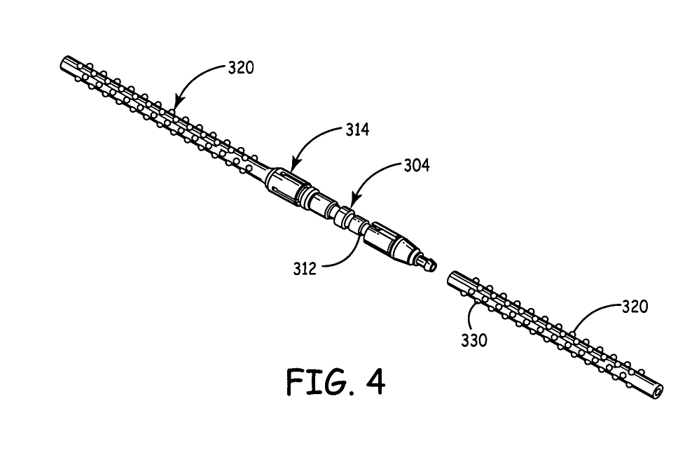

Soft, flexible elastomeric ends 120 may be provided on the ends of the collet collars 114. The flexible elastomeric ends 120 may be generally tubular and elongate and provided with suture-receiving grooves 122 or bumps 330 shown in the exemplary embodiment illustrated in FIG. 4. The elastomeric ends 120, 220 or 320 may be formed of any suitable medical grade elastomeric material, including for example silicone and polyurethane. Various reference numbers in the 300 series are used in connection with FIGS. 4 but not otherwise mentioned in this text other than by noting that such reference numbers refer to similar features as identified by 100 series reference numbers having the same last two digits.

In use, at least a portion of the implantable medical lead is positioned within the epidural space. Before, during or after the lead has been so positioned, the lead is inserted through the lumen of the anchor, and the lead anchor may be slid along the lead or catheter, for example, to the tissue to which it will be anchored. When the epidural lead is desirably positioned into the spinal epidural space, or when the catheter is desirably positioned into the intrathecal space, for example, the anchor may be slid along the lead or catheter to the tissue adjacent the opening to the epidural space or intrathecal space.

When the anchor is slid relative to the lead into the desired position, each of the first and second collet assemblies may be locked against the lead by rotating the first and second collet collars relative to the body or merely by pressing the collet collars longitudinally inwardly to make a snap-fit between the collet collars and the body. Each collet socket is pinched at the taper (provided by the funnel-shaped portion within the passage of its respective collet collar), between the collet collar and lead or catheter, resulting in a pre-determined tightness, or gripping, or wedging of the collet socket on the lead or catheter and a controlled securement of the lead or catheter in its desired position. If any further adjustment is desired, the collet collars may be rotated to release to the collet sockets and allow the anchor to slid along the lead. The anchor may be fixed to tissue by any suitable means, including for example sutures using a suture-receiving groove in the central portion of the body or suture-receiving grooves along either or both of the elastomeric ends 120.

Advantageously, if the lead or catheter needs to be repositioned, the physician may simply turn the first and second collet collars opposite the direction used for tightening, thereby releasing the lead or catheter from the collet sockets and allowing the physician to reposition the lead or catheter with respect to the lead anchor. After repositioning, the physician may simply re-turn the collet collars and re-secure the lead or catheter. Thus, in an exemplary embodiment in which sutures are only attached to the body of the anchor, the anchor would not require the removal of sutures for longitudinal repositioning of an epidural lead.

Thus, embodiments of the implantable electrical lead retention system and method are disclosed. The disclosed embodiments are presented for purposes of illustration and not limitation.

What is claimed is:

1. A medical lead anchor for anchoring a lead relative to the epidural space of a human spinal cord, the anchor comprising:
a body having first end defining a first collet socket and second end defining a second collet socket, each of the first and second collet sockets being deflectable between a locked position in which the collet socket is adapted to be fastened to a lead, and an unlocked position in which the collet socket is adapted to allow movement of the lead relative to the collet socket; and
a first collet collar and a second collet collar engaging the first and second collet sockets, respectively, and mounted on the body for movement relative to the first and second collet sockets, respectively, to move the first and second collet sockets between their locked and unlocked positions;
whereby the body is adapted to be fitted to the lead and fastened to human tissue adjacent the epidural space, and the lead is fastened by the first and second collet sockets to the anchor the lead against movement relative to the anchor and thereby relative to the human tissue and epidural space.

2. The medical lead anchor of claim 1 in which:
the first end of the body defines a first direction and the second end of the body defines a second direction opposite the first direction, the body further including a central portion between the first and second collet sockets; and
each of the first and second collet sockets has at least two deflectable cantilever arms for releasably engaging a lead, the deflectable cantilever arms of the first collet socket extending from the central portion of the body in the first direction, and the deflectable cantilever arms of the second collet socket extending from the central portion of the body in the second direction, the deflectable cantilever arms of each of the first and second collet sockets defining at least two slots extending between the deflectable cantilever arms.

3. The medical lead anchor of claim 2 in which:
the first collet socket when in its locked position provides greater retentive force against the lead in one of the first and second directions than in the other of the first and second directions; and
the second collet socket when in its locked position provides greater retentive force against the lead in the aforesaid other of the first and second directions than in the aforesaid one of the first and second directions.

4. The medical lead anchor of claim 2 in which:
the body defines a longitudinal axis extending between the first and second ends;
each of the first and second collet collars defines a passageway having a funnel-shaped portion, the passageway of the first collet collar being adapted to receive the first collet socket and the passageway of the second collet collar being adapted to receive the second collet socket;
the first collet collar being so mounted on the body that rotation of the first collet collet moves the first collet collar longitudinally relative to the body between a first position in which the funnel shaped portion of the passageway of the first collet collar does not hold the first collet socket in its locked position, and a second position in which the funnel shaped portion of the passageway of the first collet collar engages the first collet socket to hold the first collet socket in its locked position; and
the second collet collar being so mounted on the body that rotation of the second collet collar moves the second collet collar longitudinally relative to the body between a first position in which the funnel shaped portion of the passageway of the second collet collar does not hold the second collet socket in its locked position, and a second position in which the funnel shaped portion of the passageway of the second collet collar engages the second collet socket to hold the second collet socket in its locked position.

5. The medical lead anchor of claim 4 in which the funnel shaped portions of the passageways of each of the first and second collet collars deflects the deflects the cantilever arms of the first and second sockets to the locked position when the first and second collet collars, respectively, are rotated to their second positions.

6. The medical lead anchor of claim 2 in which:
the body further defines at least one collar-retaining tooth for retaining the collet collars in position to hold the collet sockets in the locked position; and
each collet collar includes at least one body-engaging tooth for engagement with at least one collar-retaining tooth of the body to retain the collet collar in position to hold the collet socket in the locked position.

7. The medical lead anchor of claim 6 in which:
the at least one collar-retaining tooth includes a first threaded section defined by the body adjacent the first collet socket, and a second threaded section defined by the body adjacent the second collet socket,
the body-engaging tooth of the first collet collar threadably engages the first threaded section, thereby allowing rotation of the first collet collar relative to the body to move the first collet socket between its locked and unlocked positions; and
the body-engaging tooth of the second collet collar threadably engages the second threaded section, thereby allowing rotation of the second collet collar relative to the body to move the second collet socket between its locked and unlocked positions.

8. The medical lead anchor of claim 6 in which:
the at least one collet-retaining tooth includes a first collet-retaining tooth for retaining the first collet collar and a second collet-retaining tooth for retaining the second collet collar;
each of the first and second collet collars is provided with at least one strain relief slot to adapt the first and second collet collars for the snap-fit engagement with at least one collet-retaining tooth;
each of the first and second collet collars is adapted to be rotated relative to the body to release the body-engaging teeth of the first and second collet collars from the first and second collet-retaining teeth, respectively; and
each of the first and second collet retaining teeth and the body-retaining teeth of the first and second collets being provided with a ramped surface to facilitate body-retaining teeth of the first and second collet collars making a snap-fit engagement with the first and second collet-retaining teeth.

9. The medical lead anchor of claim 1 further comprising at least one tissue fixation member for fixing the anchor to tissue.

10. The medical lead anchor of claim 9 in which the tissue fixation member comprises a rib defined by the body, the rib defining a suture-receiving groove.

11. The medical lead anchor of claim 9 in which the tissue fixation member comprises first and second elastomeric tubular end members mounted on and extending from the first and second collet collars, respectively, the first and second elastomeric tubular end members each having an outer surface provided with plurality of tissue engaging bumps.

12. The medical lead anchor of claim 1 in which the body further defines a lead-receiving lumen extending between the first and second ends of the body, thereby adapting the medical lead anchor to be slid into a desired position over the lead.

13. A combination of the medical lead anchor of claim 1 with an implantable medical lead having electrodes, the medical lead anchor being fitted to the lead with the first and second collet sockets engaging the lead to anchor the lead against movement relative to the anchor.

14. A system comprising the combination of claim 13 and an implantable pulse generator operatively coupled with the implantable medical lead.

15. A medical lead anchor for anchoring a lead relative to tissue, the anchor comprising:
a body having first and second ends and a lumen extending between the first and second ends for receiving a lead; and
a double-collet, lead fastening mechanism including:
a first cantilever structure extending from the first end of the body in a first direction, and a second cantilever structure extending from the second end of the body in a second direction opposite the first direction, wherein each of the first and second cantilever structures are adapted to deflect between a locked position in which the cantilever structure is adapted to fasten against the lead, and an unlocked position in which the cantilever structure is not fastened against the lead;
a first collet collar and a second collet collar, each mounted on the body for rotational movement relative to the body between:
first positions wherein, in the first position of the first collet collar, the first collet collar does not to hold the first cantilever structure in its locked position so that the first cantilever structure is free to move to its unlocked position and, in the first position of the second collet collar, the second collet collar does not hold the second cantilever structure in its locked position so that the second cantilever structure is free to move to its unlocked position; and
second positions wherein, in the second position of the first collet collar, the first collet collar holds the first cantilever structure in its locked position and, in the second position of the second collet collar, the second collet collar holds the second cantilever structure in its locked position.

16. The medical lead anchor of claim 15 in which:
the first cantilever structure when in its locked position provides greater retentive force against the lead in one of the first and second directions than in the other of the first and second directions; and
the second cantilever structure when in its locked position provides greater retentive force against the lead in the aforesaid other of the first and second directions than in the aforesaid one of the first and second directions.

17. The medical lead anchor of claim 16 in which:
the body defines a longitudinal axis extending between the first and second ends;
the first and second cantilever structures each define at least two deflectable cantilever arms and at least two slots extending between the deflectable cantilever arms;
each of the first and second collet collars defines a passageway having a funnel-shaped portion, the passageway of the first collet collar receiving the first cantilever structure and the passageway of the second collet collar receiving the second cantilever structure;
the first collet collar being so mounted on the body that rotation of the first collet collet moves the first collet collar longitudinally relative to the body between a first position in which the funnel shaped portion of the passageway of the first collet collar does not hold the first cantilever structure in its locked position, and a second position in which the funnel shaped portion of the passageway of the first collet collar deflects the cantilever arms of the first cantilever structure to hold the first cantilever structure in its locked position; and
the second collet collar being so mounted on the body that rotation of the second collet collar moves the second collet collar longitudinally relative to the body between a first position in which the funnel shaped portion of the passageway of the second collet collar does not hold the second cantilever structure in its locked position, and a second position in which the funnel shaped portion of the passageway of the first collet collar deflects the cantilever arms of the second cantilever structure to hold the second cantilever structure in its locked position.

18. The medical lead anchor of claim 17 in which:
the body further defines at least one collar-retaining tooth for retaining the collet collars in position to hold the cantilever structures in the locked position; and
each collet collar includes at least one body-engaging tooth for engagement with at least one collar-retaining tooth of the body to retain the collet collar in position to hold the cantilever structures in the locked position.

19. The medical lead anchor of claim 18 in which:
the at least one collar retaining tooth includes a first threaded section defined by the body adjacent the first cantilever structure, and a second threaded section defined by the body adjacent the second cantilever structure;
the body-engaging tooth of the first collet collar threadably engages the first threaded section, thereby allowing rotation of the first collet collar relative to the body to move the first cantilever structure between its locked and unlocked positions; and
the body-engaging tooth of the second collet collar threadably engages the second threaded section, thereby allowing rotation of the second collet collar relative to the body to move the second cantilever structure between its locked and unlocked positions.

20. The medical lead anchor of claim 19 in which:
the at least one collet-retaining tooth includes a first collet-retaining tooth for retaining the first collet collar and a second collet-retaining tooth for retaining the second collet collar, the first and second collet retaining teeth each being provided with a ramped surface to facilitate the first and second collet collars making a snap-fit engagement with the first and second collet-retaining teeth;
each of the first and second collet collars is provided with at least one strain relief slot to adapt the first and second collet collars for the snap-fit engagement with at least one collet-retaining tooth; and
each of the first and second collet collars is adapted to be rotated relative to the body to release the body-engaging teeth of the first and second collet collars from the first and second collet-retaining teeth, respectively.

21. The medical lead anchor of claim 18 further comprising at least one tissue fixation member for fixing the anchor to tissue.

22. The medical lead anchor of claim 21 in which the tissue fixation member comprises a rib defined by the body, the rib defining a suture-receiving groove.

23. The medical lead anchor of claim 21 in which the tissue fixation member comprises first and second elastomeric tubular end members mounted on and extending from the first and second collet collars, respectively, the first and second elastomeric tubular end members each having an outer surface provided with plurality of tissue engaging bumps.

24. A combination of the medical lead anchor of claim 15 with an implantable medical lead having electrodes, the medical lead anchor being fitted to the lead with the first and second collet sockets engaging the lead to anchor the lead against movement relative to the anchor.

25. A system comprising the combination of claim 24 and an implantable pulse generator operatively coupled with the implantable medical lead.

26. An implantable medical anchor for anchoring an implantable medical lead or catheter to tissue, the anchor having:
a first end and a second end, and a lumen extending between the first and second ends defining a longitudinal axis wherein the direction along the longitudinal axis from the first end toward the second end of the anchor constitutes a first direction and the direction along the longitudinal axis from the second end toward the first end constitutes a second direction, the lumen being adapted to slidably receive a lead or catheter;
a first locking means for releasably locking the anchor to a lead or catheter such that the first locking means provides greater retentive force against the lead or catheter sliding relative to the anchor in the first direction than in the second direction; and
a second locking means for releasably locking the anchor to a lead or catheter such that the second locking means provides greater retentive force against the lead or catheter sliding relative to the anchor in the second direction than in the first direction.

27. The implantable medical anchor of claim 26 in which each of the first and second locking means comprises a collet including a collet socket formed by at least two deflectable cantilever arms, the deflectable cantilever arms of the first locking means being oriented to extend longitudinally outwardly substantially in the first direction and the deflectable cantilever arms of the second locking means being oriented to extend longitudinally outwardly substantially in the second direction.

28. A method of anchoring an implantable medical lead to tissue, with an anchor, to retain the lead in the epidural space for spinal cord stimulation, the lead defining a first direction along the length of the lead and a second direction also along the length of the lead but opposite to the first direction, the anchor having a lumen for slidably receiving the lead and a double-acting collet mechanism, the double-acting collet mechanism including a first collet assembly providing greater retentive force against the lead in one of the first and second directions than in the other of the first and second directions, and a second collet assembly providing greater retentive force against the lead in the aforesaid other of the first and second directions than in the aforesaid one of the first and second directions, the method comprising:
positioning at least a portion of the implantable medical lead within the epidural space;
before, during or after the step of positioning at least a portion of the implantable medical lead within the epidural space, inserting the lead in the lumen of the anchor and sliding the anchor into position on the implantable medical lead; and
either before or after the step of positioning at least a portion of the implantable medical lead within the epidural space but after the step of inserting the lead in the lumen of the anchor and sliding the anchor into position on the implantable medical lead, locking each of the first and second collet assemblies against the lead; and
fixing the anchor relative to tissue.

29. The method of claim 28 wherein the anchor comprises a body, and each of the first and second collet assemblies comprises a collet socket forming an end of the body and deflectable between a locked position in which the collet socket is adapted to be fastened to a lead, and an unlocked position in which the collet socket is adapted to allow movement of the lead relative to the collet socket, and a collet collar mounted to the body for rotation relative to body to move the first and second collet sockets between their locked and unlocked positions; the step of locking each of the first and second collet assemblies against the lead including:
rotating the collet collar of each of the first and second collet assemblies to move the first and second collet sockets to the locked position.
